(19) United States
(12) Patent Application Publication
(10) Pub. No.: US 2007/0047172 A1
(43) Pub. Date: Mar. 1, 2007

(54) Monolithic arrangement, especially an integrated circuit, with a floating electrode

(76) Inventors: Christoph Wilbertz, Gundelfingen (DE); Heinz-Peter Frerichs, St. Peter (DE)

Correspondence Address: O'SHEA, GETZ & KOSAKOWSKI, P.C., 1500 MAIN ST., SUITE 912, SPRINGFIELD, MA, 01115, US

(21) Appl. No.: 11/503,343

(22) Filed: Aug. 9, 2006

(30) Foreign Application Priority Data
Aug. 10, 2005 (DE) 10 2005 038 100.6

(51) Int. Cl. H01G 4/255

(52) U.S. Cl. 361/272

(57) ABSTRACT

The invention relates to a monolithic arrangement, especially an integrated circuit (IC), with a floating electrode (FE), at least one conductor track (ML) for connecting the floating electrode (FE) to a system component (MS) inside the monolithic arrangement, a plurality of other conductor tracks (L) at least temporarily conducting potential in order to carry signals or currents between components (MS, GND), structures and/or contacts (K), and an insulator (IS) for electrical insulating of the conductor track (ML) and the other conductor tracks (L) from each other, wherein one layout of the conductor track (ML) and of the other conductor tracks (L) is such that the path of the conductor track (ML) does not cross the path of any of the conductor tracks (L). It is advisable to maintain a minimum distance between the measuring conductor track and the other conductor tracks.

### PRIORITY INFORMATION

This patent application claims priority from German patent application 10 2005 038 100.6 filed Aug. 10, 2005, which is hereby incorporated by reference.

### BACKGROUND INFORMATION

The invention relates to a monolithic arrangement, especially an integrated circuit with a floating electrode.

Generally known are monolithic arrangements, such as glass or plastic or silicon substrates, and integrated circuits with a plurality of potential-conducting tracks to carry signals/currents between components, structures, and/or contacts of the circuit, with a measuring sensor to detect a physical magnitude. At least one measuring track may connect the measuring sensor to a measuring system component and with an insulator for electrical insulation of the conductor tracks.

In such monolithic or integrated circuits, because of the planar arrangement of the components, a plurality of conductor tracks is needed on various levels, separated from each other by electrically insulating layers, such as insulators. These insulating layers also in theory allow different conductor tracks to cross each other. The insulation layers are generally formed by thermal or deposited silicon oxides.

The circuit layout becomes problematical when the integrated circuit has so-called floating electrodes. Floating electrodes are conductor tracks that are totally surrounded by insulators and whose potential can change, (i.e., float). Such floating electrodes are a part of, for example, integrated measuring sensors, of EEPROMs and EPROMs, and of CC-FETs.

When conductor tracks cross each other, heat or light can generate electron-hole pairs in the insulator located between the conductor tracks, which result in an unwanted charge equalization between the neighboring conductor tracks, especially for floating electrodes. When requirements demand a very large insulation for a conductor track or electrode, this leads to measurement inaccuracies or drift problems.

There is a need for an integrated circuit in which such a charge equalization is prevented.

### SUMMARY OF THE INVENTION

A monolithic arrangement or integrated circuit includes a floating electrode, a first conductor track for connecting the floating electrode to a system component with a plurality of other conductor tracks at least temporarily conducting potential in order to carry signals or currents between components, structures and/or contacts and with an insulator for electrically insulating the first conductor track and the other conductor tracks from each other. The layout of the first conductor track and the other conductor tracks is such that the path of the first conductor track does not cross the path of any of the conductor tracks.

It makes no difference whether or not the other conductor tracks are arranged on this monolithic arrangement or this integrated semiconductor circuit or another monolithic arrangement or another integrated circuit.

The monolithic arrangement can also be an arrangement having no active electronic component, but merely a floating electrode, making contact with the outside via bond pads.

Especially preferred is an integrated circuit in which the insulator is a silicon oxide.

The insulator may be configured as an insulation layer between the measuring conductor track and at least one of the other conductor tracks.

Especially preferred is a measuring sensor circuit with such an integrated circuit with a measuring sensor.

Especially preferred is a method of producing an integrated measuring sensor circuit with a floating electrode, at least temporarily potential-carrying conductor tracks, and at least one additional conductor track, wherein the conductor track of at least one additional conductor track is set apart and electrically insulated by an insulator, wherein the layout of the conductor track and of the additional conductor tracks is such that the conductor track does not cross any of the other conductor tracks.

The term “measuring sensor” is broadly construed and comprises, in particular, also a measuring electrode for connecting a measuring sensor. The system component in one simple instance can be formed, for example, by a transistor or the like, amplifying a measurement signal, and need not necessarily constitute a complete circuit arrangement.

In particular, a biosensor can also be used as the measuring sensor. With such biosensors, one can analyze biomaterial, such as human or animal skin cells, hair cells, nerve cells, blood cells or the like, by plating the biomaterial on the floating electrode. In particular, living cells such as nerve cells can be analyzed with so-called neurochip sensors.

To avoid possible high-resistive leakage currents induced by heat and light between the conductor track going, for example, to a measuring electrode or the measuring sensor, and lines or conductor tracks for the power supply voltage, a ground potential, or conductor tracks serving as signal lines, lines from a measuring system, such as a transistor as the measuring system component, to the measuring electrode or the measuring sensor are configured such that they do not cross any other potential-carrying conductor tracks or come too close to them.

Possible applications of the invention are circuit arrangements with floating, insulated lines or electrodes, such as in an EPROM or EEPROM or capacitive coupled gas sensors (CC-FET).

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates an integrated circuit arrangement with a first conductor track and, at a distance from it, other conductor tracks carrying potential; and

FIG. 2 is a partial sectional view through an integrated circuit with a multilayered construction.

### DETAILED DESCRIPTION OF THE INVENTION

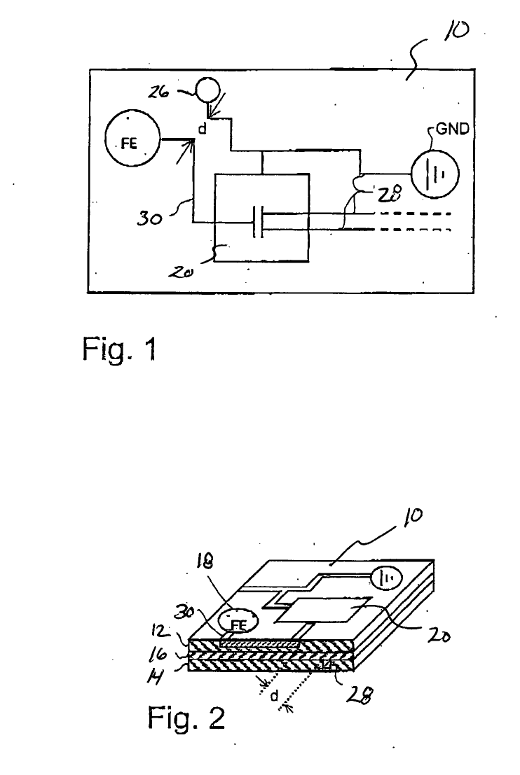

Referring to FIG. 1 and FIG. 2, an integrated circuit 10 includes several layers 12, 14, which are electrically insulated and spaced apart by an insulator 16. The integrated circuit 10 typically contains a plurality of components and structures, such as a floating electrode 18, a system component 20 of the type of an evaluation circuit, e.g., for measurement signals of the measuring sensor ME, and a ground potential or grounding lead GND, as well as other components or contacts 26 for connecting external components.

The plurality of different components and structures are joined together as needed, typically by a plurality of corresponding conductor tracks 28. For example, the floating electrode 18 is connected by a first conductor track 30 to the system component 20, while the system component 20 is formed, for example, from a transistor amplifying a measurement signal or a complex evaluation circuit.

The conductor tracks 28, 30 in a multilayer construction of the integrated circuit 10 can be distributed among the different layers 12, 14 so as to also enable crossovers between the individual conductor tracks 28 in a simple manner.

The insulator 16 is preferably made of silicon oxide or another suitable material. When designing a layout for the first conductor track or other conductor tracks, attention is paid to maintaining a minimum distance d from other conductor tracks 28, which are at least sometimes potential-carrying. Furthermore, direct crossovers of the measuring conductor track 30 and other, sometimes potential-carrying conductor tracks 28 are avoided, so that preferably in both the layer of the first conductor track 30 and in the direction perpendicular to this layer of the first conductor track 30 the minimum distance d is maintained.

Ideally, thus, a minimum distance is maintained and furthermore attention is paid to avoiding crossovers when establishing the layout of the first conductor track 30 relative to the other conductor tracks 28.

To determine the minimum distance d in the method of producing such an integrated circuit 10, one can perform a plurality of empirical experiments, advantageously taking into account the particular materials used for the insulator 16 and the maximum potentials occurring on the lines 28 neighboring the measurement line. Advantageously, a mathematical determination of the minimum distance d is possible if one has knowledge of these corresponding physical magnitudes. To enable an optimal reduction of the surface required for the integrated circuit 10, the minimum distance d is calculated as a minimum distance so as to avoid too large a distance of more than 1.5 times or especially 2 times the minimum distance d from other conductor tracks 28.

Although the present invention has been illustrated and described with respect to several preferred embodiments thereof, various changes, omissions and additions to the form and detail thereof, may be made therein, without departing from the spirit and scope of the invention.

What is claimed is:

1. A monolithic arrangement (IC) comprising:
a floating electrode;
a first conductor track for connecting the floating electrode to a system component inside the monolithic arrangements;
a plurality of other conductor tracks at least temporarily conducting potential in order to carry signals or currents between components, structures and/or contacts; and
an insulator for electrical insulating of the conductor track and the other conductor tracks from each other,
where the layout of the conductor track and of the other conductor tracks is such that the path of the first conductor track does not cross the path of any of the conductor tracks.

2. The monolithic arrangement of claim 1, where the insulator comprises silicon oxide.

3. The monolithic arrangement of claim 1, where the insulator is configured as an insulation layer between the first conductor track and at least one of the other conductor tracks.

4. The monolithic arrangement of claim 1, where the floating electrode is part of a measuring sensor.

5. The monolithic arrangement of claim 1, where the floating electrode is part of an EEPROM, an EPROM, or a CC-FET.

6. The monolithic arrangement of claim 1, where this monolithic arrangement is an integrated semiconductor circuit.

7. (canceled)

8. The monolithic arrangement of claim 4, where the measuring sensor comprises a bio sensor.
